(19) United States
(12) Patent Application Publication
(10) Pub. No.: US 2022/0026892 A1
(43) Pub. Date: Jan. 27, 2022

(54) ANOMALY DETECTION DEVICE, MACHINE TOOL, ANOMALY DETECTION METHOD, AND PROGRAM

(71) Applicant: FUJI CORPORATION, Chiryu (JP)

(72) Inventors: Go UCHIDA, Chiryu-shi (JP); Hirotake ESAKI, Ichinomiya-shi (JP); Hiroshi OIKE, Chiryu-shi (JP); Anusuya NALLATHAMBI, Chiryu-shi (JP)

(73) Assignee: FUJI CORPORATION, Chiryu (JP)

(21) Appl. No.: 17/311,582

(22) PCT Filed: Dec. 12, 2018
(86) PCT No.: PCT/JP2018/045640

§ 371 Date: Jun. 7, 2021

(51) Int. Cl. G05B 23/02; G05B 19/18; G05B 19/19; B23Q 17/09; B23B 49/00

(52) U.S. Cl. CPC G05B 23/0235; G05B 23/0221; B23B 49/00; G05B 19/195; B23Q 17/0952; G05B 19/182

(57) ABSTRACT

An anomaly detection device of a machine tool includes a time series data acquisition section for acquiring target time series data that is the time series data of a moving load in the Z-axis direction of a cutting tool of the machine tool during a drilling process, an evaluation value derivation section for deriving an evaluation value indicating a degree of similarity between at least a part of the acquired target time series data and at least a part of reference time series data that is time series data of the moving load that can be regarded as normal using singular spectrum transformation, and an anomaly determination section for determining the presence or absence of an anomaly of the machine tool based on the derived evaluation value.

### TECHNICAL FIELD

The present specification discloses an anomaly detection device, a machine tool, an anomaly detection method, and a program.

### BACKGROUND ART

Conventionally, there is a device known for detecting breakage of a tool of a machine tool for performing a drilling process. For example, the NC device (numerical control device) described in Patent Literature 1 detects a tool failure of a main shaft based on the magnitude of current flowing through a servo motor. Specifically, the failure detecting signal is outputted when the sensed current exceeds a set value of current corresponding to an abnormal feed load of the main shaft for a predetermined time period.

### PATENT LITERATURE

Patent Literature 1: Japanese Laid-open Patent Publication No. 11-170105

### BRIEF SUMMARY

### Technical Problem

However, in the method of merely determining an anomaly based on the magnitude and the set value of a current as disclosed in Patent Literature 1, the detection accuracy of the anomaly may be insufficient.

The present disclosure has been made to solve the above-mentioned problem, and it is a principal object of the present disclosure to accurately detect an anomaly in a machine tool.

### Solution to Problem

The present disclosure adopts a configuration, which will be described below, to achieve the main object described above.

The anomaly detection device of the present disclosure is an anomaly detection device of a machine tool,

the machine tool comprising:
a cutting tool configured to perform drilling,
a first driving section configured to axially rotate the cutting tool, and
a second driving section configured to move the cutting tool in the Z-axis direction that is the axial direction of the cutting tool; and
the anomaly detection device comprising:
a time series data acquisition section for acquiring target time series data that is the time series data of a moving load in the Z-axis direction of the cutting tool during the drilling process,
an evaluation value derivation section for deriving an evaluation value indicating a degree of similarity between at least a part of the acquired target time series data and
at least a part of reference time series data that is time series data of the moving load that can be regarded as normal using singular spectrum transformation, and
an anomaly determination section for determining the presence or absence of an anomaly of the machine tool based on the derived evaluation value.

The anomaly detection device first acquires target time series data, which is time series data of the moving load in the Z-axis direction of the cutting tool during the drilling process. The anomaly detection device next derives an evaluation value indicating the degree of similarity between at least a part of the target time series data and at least a part of the reference time series data, which is the time series data of the moving load deemed to be normal, using singular spectrum transformation (also called singular spectrum analysis). The anomaly detection device then determines whether there is an anomaly in the machine tool based on the evaluation value. By using singular spectrum transformation, the anomaly detection device derives an evaluation value indicating the degree of similarity between the characteristic patterns of each of the target time-series data acquired this time and the reference time-series data. Accordingly, in this anomaly detection device, by determining the presence or absence of an anomaly based on the derived evaluation value, it is possible to accurately detect an anomaly of the machine tool compared with, for example, the case where the anomaly is determined based merely on the magnitude of the current. An anomaly of the machine tool is, for example, breakage of a blade tool. In this case, the evaluation value may be a degree of similarity or a degree of change.

### BRIEF DESCRIPTION OF DRAWINGS

FIG. 1 A front view showing a schematic configuration of machine tool 10.

FIG. 2 A block diagram showing electrical connections of machine tool 10.

FIG. 3 A flowchart showing an example of an anomaly detection process routine.

FIG. 4 A conceptual diagram showing a target time series matrix X₁ generated from target time series data.

FIG. 5 A conceptual diagram showing a target characteristic matrix U1 derived from the target time series matrix X₁.

### DESCRIPTION OF EMBODIMENTS

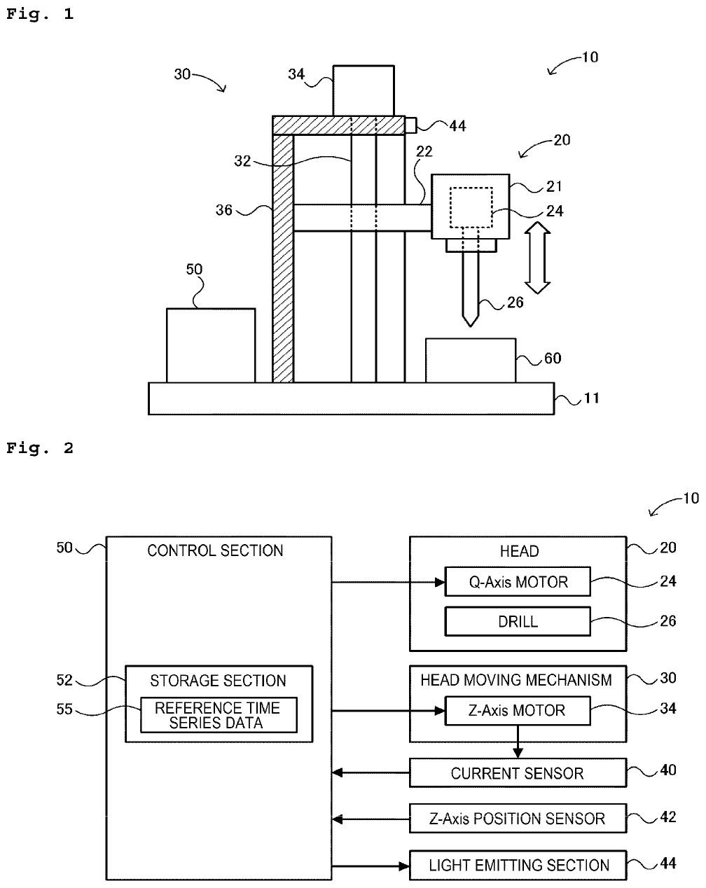

Machine tool 10 which is an example of an anomaly detection device and a machine tool of an embodiment of the present disclosure will be described below with reference to the accompanying drawings. FIG. 1 is a front view showing a schematic configuration of machine tool 10, and FIG. 2 is a block diagram showing electrical connections of machine tool 10. The hatched portion in FIG. 1 is a cross-section in which guide member 36 is cut in a plane parallel to the drawing sheet. Machine tool 10 is a machine for lifting and lowering drill 26 (an example of a cutting tool) to perform a drilling process on object 60 such as a metal member. Machine tool 10 includes base 11, head 20, head moving mechanism 30, current sensor 40 (see FIG. 2), Z-axis position sensor 42 (see FIG. 2), light emitting section 44, and control section 50. Head 20, head moving mechanism 30, and control section 50 are disposed on base 11. Object 60 to be drilled is placed on base 11 and directly below drill 26 of head 20.

Head 20 is a device for performing a drilling process on object 60 by lifting and lowering drill 26 while axially rotating drill 26. Head 20 includes head main body 21, lifting/lowering plate 22, Q-axis motor 24 (one example of a first driver), and drill 26. Head body 21 is a member having an approximate rectangular parallelepiped shape, and Q-axis motor 24 is disposed therein. Lifting/lowering plate 22 is connected to the left side of head main body 21. Lifting/lowering plate 22 is a plate-shaped member and is attached to ball screw 32, extending in the up-down direction, in a manner which allows lifting/lowering plate 22 to go up and down. Q-axis motor 24 outputs a rotational driving force to axially rotate drill 26. Drill 26 is a member for performing a drilling process on object 60. Drill 26 is attached in an exchangeable manner to the underside of head 20. The axial direction of drill 26 is an up-down direction indicated by the arrow in FIG. 1. The up-down direction is also called the Z-axis direction.

Head moving mechanism 30 is a mechanism for moving head 20 in the Z-axis direction, that is, for lifting and lowering head 20. Head moving mechanism 30 includes ball screw 32, Z-axis motor 34 (one example of a second driver), and guide member 36. Ball screw 32 is disposed so that the axial direction thereof is parallel to the Z-axis direction and penetrates lifting/lowering plate 22 in the up-down direction. Z-axis motor 34 is configured as, for example, a servo motor, is disposed above ball screw 32, and outputs a rotational driving force to axially rotate ball screw 32. Guide member 36 is a box-shaped member having an inner space opened to the right side in FIG. 1, and ball screw 32 and lifting/lowering plate 22 are disposed in the inner space. Guide member 36 includes a guide rail (not shown) on the inner peripheral face thereof and guides the lifting and lowering of lifting/lowering plate 22. Z-axis motor 34 is disposed on guide member 36. Head moving mechanism 30 moves the entire head 20 including drill 26 in the Z-axis direction by lifting and lowering lifting/lowering plate 22 by causing Z-axis motor 34 to rotate ball screw 32.

Current sensor 40 (see FIG. 2) measures the drive current of Z-axis motor 34. The drive current of Z-axis motor 34 correlates with the torque of the drive shaft of Z-axis motor 34 and ball screw 32, whereas the torque of ball screw 32 correlates with the moving load in the Z-axis direction of drill 26. Therefore, the drive current of Z-axis motor 34 is information indicating the moving load of drill 26 in the Z-axis direction.

Z-axis position sensor 42 (see FIG. 2) is a sensor for sensing the position of head 20 in the Z-axis direction. In the present embodiment, Z-axis position sensor 42 is a laser displacement type sensor attached to head 20. Z-axis position sensor 42 irradiates laser light downward, receives the laser light after being reflected by the upper surface of base 11, and senses the position of head 20 in the Z-direction based on the difference in the light receiving position of the laser light.

Light emitting section 44 is a light source unit having multiple LEDs of each of three colors of red, green, and blue, and can emit light in various colors. Light emitting section 44 is disposed on the right face of the upper end portion of guide member 36. Light emitting section 44 is used, for example, to notify an operator of an anomaly.

Control section 50 is configured as a microcomputer centered on a CPU (not shown) and includes ROM for storing various programs, RAM for temporarily storing data, an input/output port (none of which are shown), and the like in addition to the CPU. Control section 50 also includes storage section 52 configured by an HDD or the like. Storage section 52 stores reference time series data 55 described later. Control section 50 outputs control signals to and controls Q-axis motor 24, Z-axis motor 34, and light emitting section 44. In addition, the current value of ball screw 32 outputted from current sensor 40, the position sensing signal from Z-axis position sensor 42, and the like are received by control section 50.

Next, an operation when machine tool 10 performs a drilling process for drilling object 60 will be described. Machine tool 10 performs a drilling process on object 60, for example, based on a production program received from a management device (not shown), and repetitively executes the drilling process. The production program includes information such as the shape of object 60, the depth of the hole to be drilled, and the number of objects 60 to be drilled. When machine tool 10 performs the drilling process, object 60 is first conveyed to base 11 by a conveyance device (not shown) such as a robot arm or a belt conveyor, and is positioned directly below drill 26. Control section 50 of machine tool 10 next drives Q-axis motor 24 to rotate drill 26 and drives Z-axis motor 34 to lower drill 26. Control section 50 then lowers head 20 based on the position sensing signal from Z-axis position sensor 42 until a hole having a depth to be formed in object 60 is drilled. Thereafter, control section 50 causes Z-axis motor 34 to lift drill 26 to retract drill 26 to an area above object 60. Thereafter, object 60 subjected to a drilling process is conveyed from machine tool 10 by a conveyance device (not shown) and sent to, for example, the next step. Machine tool 10 repetitively executes such a drilling process a number of times determined by the production program. Here, the process in which drill 26 actually cuts object 60 in the drilling process is referred to as a drilling process. That is, one drilling process refers to a lowering of drill 26 until drill 26 finishes descending after coming in contact with object 60.

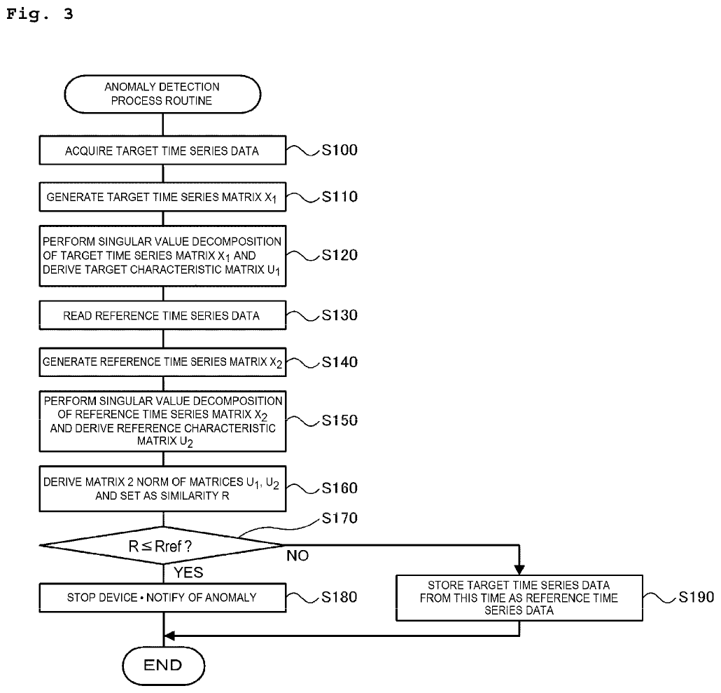

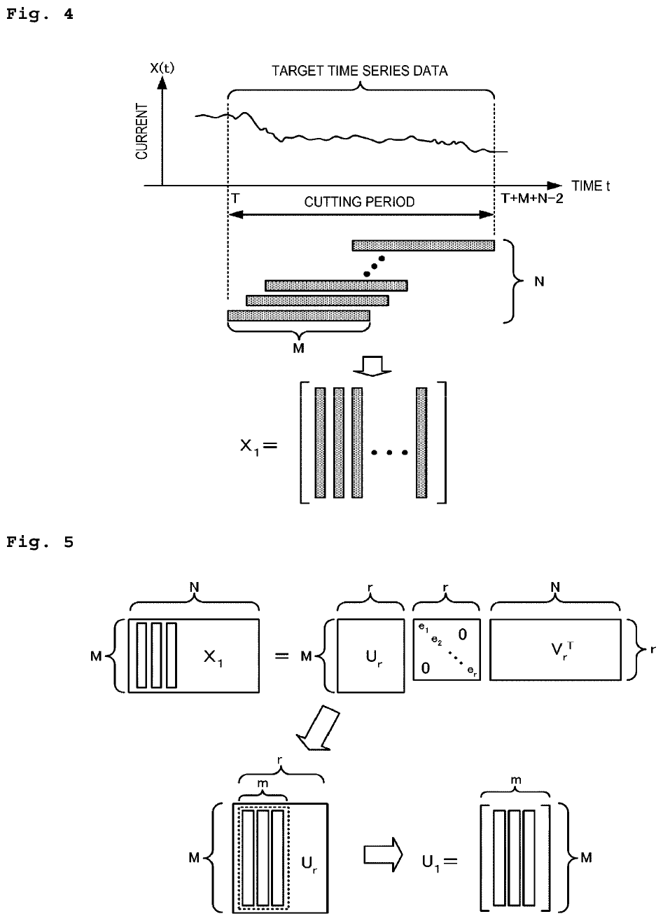

When performing the drilling process, machine tool 10 performs an anomaly detection process for detecting an anomaly of machine tool 10 such as, for example, breakage of drill 26. FIG. 3 is a flowchart showing an example of an anomaly detection process routine, FIG. 4 is a conceptual diagram showing a target time series matrix X₁ generated from target time series data, and FIG. 5 is a conceptual diagram showing a target characteristic matrix U₁ derived from a target time series matrix X₁. The anomaly detection process routine is stored in, for example, storage section 52 and is started when the drilling process starts (for example, when lowering of drill 26 starts).

When the execution of the anomaly detection process routine is started, control section 50 first acquires target time series data, which is the time series data of the moving load in the Z-axis direction of drill 26 during the drilling process (S100). In the present embodiment, as described above, the drive current of Z-axis motor 34 is used as information indicating the moving load in the Z-axis direction of drill 26. Accordingly, in S100, control section 50 acquires the target time series data based on the drive current measured by current sensor 40. The waveform shown in FIG. 4 is an example of a waveform of the drive current measured by current sensor 40. The “cutting period” in FIG. 4 represents a period during which one drilling operation is performed. In the present embodiment, control section 50 acquires a waveform of the drive current from the beginning to the end of the cutting period as the target time series data. Control section 50 can detect the start and end of the cutting period, for example, based on the positional information of head 20 acquired from Z-axis position sensor 42, the height of object 60 included in the production program, the depth of the hole to be formed, and the like, and acquire the target time series data. Specifically, the target time series data is, for example, a set of data in which time (or a measurement sequence) and current values are associated with each other. Let t be the time, and let the current value at time t be X(t). The target time series data are data of (M+N−1) current values from time T to time (T+M+N−2). M, N will be described later.

Subsequently, control section 50 generates a target time series matrix X₁ represented by the following expression (1) based on at least some of the target time series data acquired in S100 (S110).

$${X}_{1} = [ \begin{matrix}X ( T ) & X ( T + 1 ) & ⋯ & X ( T + N - 1 ) \\ X ( T + 1 ) & X ( T + 2 ) & ⋯ & X ( T + N ) \\ ⋮ & ⋮ & ⋮ & ⋮ \\ X ( T + M - 1 ) & X ( T + M ) & ⋯ & X ( T + M + N - 2 )\end{matrix} ] \qquad ( 1 )$$

In the present embodiment, control section 50 generates the target time series matrix X₁ using all of the target time series data acquired in S100. As can be understood from the following expression (1) and FIG. 4, the target time series matrix X₁ is generated, for example, as follows. First, control section 50 extracts a partial time series (also referred to as a slide window) of M consecutive current values from time T among the target time series data (X(T), X(T+1), . . . , X(T+M+N−2) to form a column vector constituting the target time series matrix X₁. Control section 50 then extracts a total of N column vectors by shifting the positions from time T to time (T+N−1) one by one and arranges them in the column direction to obtain a target time series matrix X₁ of M rows and N columns. As described above, control section 50 creates a matrix having N sets of M pieces of data by extracting multiple pieces of data of M consecutive current values (partial time series) at different times based on the target time series data. The values of M and N can be determined in advance by experiments, for example, as values capable of accurately detecting an anomaly without increasing the amount of data excessively. It should be noted that when the number of pieces of data of the target time series data is larger than the number (M+N−1) used to generate the target time series matrix X₁, control section 50 may generate the target time series matrix X₁ using data from a part of the target time series data.

Next, control section 50 derives a target characteristic matrix U₁ indicating a characteristic pattern (hereinafter, a characteristic pattern) of the target time series data based on the result of singular value decomposition of the target time series matrix X₁ generated in S110 (Step S120). In S120, control section 50 first decomposes the target time series matrix X₁ of M rows and N columns by singular values to derive a left singular matrix Uᵣ, a diagonal matrix of r rows and r columns, and the matrix VrT (see the upper portion of FIG. 5). The left singular matrix Uᵣ is a matrix of M rows and r columns. The diagonal matrix is a matrix of an r matrix and an r matrix each having e₁, e₂, . . . , eᵣ as diagonal elements. The matrix VrT is a matrix of r rows and N columns and is a transposed matrix of the right singular matrix Vr. r is the rank of the target time series matrix X₁. Such a singular value decomposition is well known and is described, for example, in reference literature (Tsuyoshi Ide, “Introduction to Anomaly Detection using Machine Learning—Practical Guide using R-”, Corona Corporation, Mar. 13, 2015). Subsequently, control section 50 derives the target characteristic matrix U₁ of M rows and tm columns including the elements of the first column to the m-th column (m is an integer that is not greater than r) of the left singular matrix Uᵣ, based on the left singular matrix Uᵣ derived by the singular value decomposition (see the lower portion of FIG. 5). The target characteristic matrix U₁ obtained in this manner is data indicating a characteristic pattern of the target time series data (more specifically, the target time series matrix X₁ based on the target time series data). Here, in the left singular matrix Uᵣ, the more one progresses from the r-th column to the first column, the more data indicating the overall or dominant characteristic pattern of the target time series matrix X₁. Therefore, the target characteristic matrix U₁ including the elements in the first column to the m-th column of the left singular matrix Uᵣ is configured to be data indicating a characteristic pattern useful for determining the anomaly detection in the target time series matrix X₁ by removing the influence of elements such as noise of the current waveform unnecessary for the anomaly detection. The value of m can be determined in advance by experiments so as to enable accurate detection of an anomaly.

Next, in S130, control section 50 reads reference time series data 55 stored in storage section 52. Reference time series data 55 is time series data of the moving load in the Z-axis direction of drill 26 at the time of the drilling operation deemed to be normal. In the present embodiment, object 60 is drilled in advance in a state where there are no anomalies in machine tool 10 such as breakage or chipping of drill 26, reference time series data 55 is generated based on the drive current of Z-axis motor 34 measured at this time and is stored in storage section 52.

Subsequently, control section 50 generates the reference time series matrix X₂ based on the data of at least a part of reference time series data 55 read in S130 (Step S140). Since S140 can be performed in the same manner as the generation of the target time-series matrix X₁ in S110 described above, detailed descriptions thereof will be omitted. The values of M and N in S140 are the same as those in S110.

Thereafter, control section 50 derives a reference characteristic matrix U₂ indicating the characteristic pattern of reference time series data 55 based on the result of singular value decomposition of the reference time series matrix X₂ generated in S140 (Step S150). Since S150 can be performed in the same manner as the derivation of the target characteristic matrix U₁ in S120 described above, detailed descriptions thereof will be omitted. The value of m in S150 is set to the same value as in S120. The derived reference characteristic matrix U₂ is data indicating a characteristic pattern useful for determining anomaly detection among the reference time series matrix X₂.

Control section 50 then derives a matrix 2 norm from the matrix product of the target characteristic matrix U₁ derived in S120 and the reference characteristic matrix U₂ derived in S150 by the following equation (2) and sets the derived value as the similarity R (Step S160). The matrix 2 norm is well known and is described, for example, in the above-mentioned references. The similarity R has a larger value as the characteristic pattern of the target time series data (more specifically, the target time series matrix X₁ based on the target time series data) and the characteristic pattern of reference time series data 55 (more specifically, the reference time series matrix X₂ based on reference time series data 55) are similar to each other. Here, a method of obtaining characteristic patterns of two sets of time series data (here, the target characteristic matrix U₁ and the reference characteristic matrix U₂) using singular value decomposition is referred to as singular spectrum transformation. Control section 50 then derives the similarity R indicating the degree of similarity between the two (in other words, the degree of change between the two) based on the two characteristic patterns obtained by using singular spectrum transformation. As described above, in the present embodiment, by using singular spectrum transformation, control section 50 derives the similarity R as an evaluation value that accurately indicates the degree of similarity between the characteristic pattern of the target time series data and reference time series data 55, from which, for example, the influence of noise that causes different current waveforms every time is removed.

R=∥U₁^{T}U₂∥₂ (2)

When the similarity R is derived in S160, control section 50 determines whether there is an anomaly in machine tool 10 based on the similarity R (Step S170). In the present embodiment, control section 50 determines that there is an anomaly when the similarity R is less than or equal to the predetermined threshold value Rref. The threshold value Rref can be determined in advance by, for example, experiment.

If it is determined in S170 that there is an anomaly, control section 50 stops the operation of machine tool 10, for example, by stopping Q-axis motor 24 and Z-axis motor 34, causes light emitting section 44 to emit light to notify the operator of the anomaly (Step S180) and terminates the present routine. The notification of the anomaly may be performed not only by light emission but also by outputting a sound, or may be performed by outputting a signal for notifying the anomaly to a management device of machine tool 10, a terminal owned by an operator, or the like.

On the other hand, when it is determined in S170 that there are no anomalies, control section 50 stores (in this case, overwrites) the target time series data acquired in S100 this time in storage section 52 as reference time series data 55 (Step S190). If control section 50 determines in S170 that there are no abnormalities, the target time series data acquired in S100 this time can be regarded as normal time series data. Therefore, control section 50 stores the target time series data in storage section 52 so as to use the target time series data as new reference time series data 55. As a result, when the next anomaly detection process routine is executed, control section 50 reads the target time series data acquired in S100 that is the latest (last time) in S130 from storage section 52 as reference time series data 55.

Here, the correspondence between configuration elements of the present embodiment and configuration elements of the present disclosure will be specified. Machine tool 10 of the present embodiment corresponds to a machine tool and an anomaly detection device of the present disclosure, drill 26 corresponds to a cutting tool, Q-axis motor 24 corresponds to a first driver, Z-axis motor 34 corresponds to a second driver, and control section 50 corresponds to a time series data acquisition section, an evaluation value derivation section, and an anomaly determination section. In the present embodiment, an example of the anomaly detection method of the present disclosure is also disclosed by describing the operation of control section 50.

In machine tool 10 of the present embodiment described in detail above, control section 50 first acquires target time series data that is the time series data of the moving load in the Z-axis direction of drill 26 (in this case, the current of Z-axis motor 34) during the drilling process. Next, control section 50 uses singular spectrum transformation to derive an evaluation value (here, the similarity R) indicating the degree of similarity between at least a part of the target time series data and at least a part of the reference time series data 55, which is the time series data of the current of Z-axis motor 34 deemed to be normal. Control section 50 then determines whether there is an anomaly in machine tool 10 based on the similarity R. By using the singular spectrum transformation, control section 50 can derive the similarity R indicating the degree of similarity between the characteristic patterns of each of the target time-series data acquired this time and reference time-series data 55. Accordingly, in machine tool 10, by determining the presence or absence of an anomaly based on the similarity R derived by control section 50, it is possible to accurately detect an anomaly of machine tool 10, such as a fracture of drill 26, as compared with, for example, a case where the anomaly is determined merely based on the magnitude of the current. For example, the target time series data and the reference time series data 55 are ideally the same data, but are actually affected by various noises and the like. Therefore, even if the target time series data is normal data, the target time series data and reference time series data 55 are not exactly the same. Even in such a case, in machine tool 10 of the present embodiment, by using the above-described method, it is possible to accurately detect an anomaly of machine tool 10 while preventing erroneous detection or erroneous non-detection of an anomaly.

In addition, since control section 50 performs S190 described above, the similarity R is derived using the target time series data acquired at the time of the drilling process that is not determined to be abnormal in S170 of the anomaly detection process and was performed one time ago as reference time series data 55. Accordingly, control section 50 derives the similarity R when the time series data that was last (previously) deemed as normal is used as reference time series data 55. Therefore, for example, even in a case where the time-series data at the time of normal drilling changes with age, it is unlikely to erroneously detect the change with age as an anomaly. Accordingly, in machine tool 10, it is possible to detect an anomaly of machine tool 10 with higher accuracy.

As a matter of course, the present disclosure is not limited to the above-described embodiment and may be implemented in various aspects as long as the aspects belong within the technical scope of the present disclosure.

For example, in the above embodiment, in S100, control section 50 acquires time series data of the drive current of Z-axis motor 34 from the beginning to the end of one drilling operation (cutting period). However, the present disclosure is not limited to this, and control section 50 may obtain the time series data of at least a part of the time period during one drilling operation as the target time series data. In the above embodiment, control section 50 generates the target time series matrix X₁ using all of the acquired target time series data (from time T to time T to time T+M+N−2), but the present disclosure is not limited to this, and the target time series matrix X₁ may be generated using at least some of the acquired time series data. That is, the target time series matrix X₁ may be generated based on time series data of the drive current in at least a part of the period from the beginning to the end of one drilling operation. The same applies to reference time series data 55 and the reference time series matrix X₂. In the case where time series data of a part of the cutting period is used, it is preferable that the time T has the same value (time series data of the same period among the cutting periods) between the target time series matrix X₁ and the reference time series matrix X₂, but the time T may be different from each other.

In this case, control section 50 need not use the time series data of the drive current of Z-axis motor 34 for a predetermined period on the starting side of one drilling operation to derive the similarity R. For example, control section 50 need not include the time series data of the predetermined period in the target time series data, or may include the time series data in the target time series data but need not be used to generate the target time series matrix X₁. As a result, the number of pieces of data used to derive the similarity R can be reduced, thus reducing the processing load on control section 50. In addition, even if an anomaly occurs during a predetermined period on the starting side of one drilling operation, if the anomaly continues, the anomaly is often reflected in the similarity R derived using the time series data of the remaining period after the predetermined period. Therefore, even if the time series data of the drive current for the predetermined period on the starting side is not used to derive the similarity R, the accuracy of the anomaly detection of machine tool 10 is unlikely to be reduced. As described above, it is possible to reduce the processing burden on control section 50 while suppressing deterioration of the accuracy of the anomaly detection of machine tool 10. The predetermined period may be a period including the first half of one drilling operation.

In the above embodiment, although control section 50 necessarily performs the process of S190 when it is determined that there is no anomaly in S170, the process is not limited to this. For example, control section 50 may count the number of times it is determined that there is no anomaly in S170 and perform the process in S190 when the counted number reaches a predetermined number P(>1). As a result, control section 50 uses, as reference time series data 55, the target time series data that is relatively recent (any one of first time to P times ago) for which it is determined that there is no anomaly in S170. Even in this manner, as in the above-described embodiment, it is unlikely to erroneously detect a change in the time-series data during normal drilling processes due to age as an anomaly. In addition, compared with the case where S190 is performed each time as in the above embodiment, the processing load of control section 50 can be reduced. It should be noted that the case where the predetermined number of times P in this example is set to 1 corresponds to the above-described embodiment. In addition, control section 50 may not perform S190 at all. Even in this case, by storing reference time series data 55 in advance in storage section 52, the similarity R can be derived based on reference time series data 55.

In the above embodiment, control section 50 derives the similarity R as an evaluation value indicating the degree of similarity between the target time series data and reference time series data 55, but the present disclosure is not limited to this. For example, the degree of change A represented by the following expression (3) may be derived as the evaluation value. The degree of change A has a smaller value the more the characteristic pattern of the target time series data (more specifically, the target time series matrix X₁ based on the target time series data) and the characteristic pattern of reference time series data 55 (more specifically, the reference time series matrix X₂ based on reference time series data 55) are similar to each other. Accordingly, control section 50 may determine that there is an anomaly in machine tool 10, for example, when the degree of change A is derived in S160 and the degree of change A exceeds a predetermined threshold ARef in S170.

A=1−(∥U₁^{T}U₂∥₂)₂ (3)

In the above embodiment, the drive current of Z-axis motor 34 is used as information indicating the moving load in the Z-axis direction of drill 26 during the drilling process, but the present disclosure is not limited to this. For example, the torque of the drive shaft of Z-axis motor 34 or the torque of ball screw 32 may be measured by a torque meter, and this may be used as information indicating the moving load.

In the above embodiment, the time series data of the moving load in the Z-axis direction of drill 26 is used, but instead of this, it is conceivable to use the time series data of the load of the axial rotation of drill 26 (e.g., the torque or the current of Q-axis motor 24) as the target time series data and the reference time series data. However, particularly in the case where the diameter of drill 26 is small, the load of the axial rotation of drill 26 is likely to be small due to a light weight of drill 26, a small moment for rotating drill 26, a small cutting area of object 60 by drill 26, a small cutting resistance, and the like. Then, when the load of the axial rotation of drill 26 is small, the size of the time series data (e.g., the size of X(t) in FIG. 4) is small overall such that the difference between the time series data at the time of normal operation and the time of abnormal operation is also small, thus making it difficult to detect an anomaly. On the other hand, by using the time series data of the moving load in the Z-axis direction of drill 26 as in the present embodiment, it is possible to detect the anomaly of machine tool 10 in a stable manner regardless of the size of the diameter of drill 26. Here, the diameter of drill 26 may be smaller than the diameter of ball screw 32. Even in this case, for the reasons described above, machine tool 10 of the present embodiment can accurately detect an anomaly of machine tool 10.

In the above embodiment, reference time series data 55 is stored in storage section 52, but the present disclosure is not limited to this. Since the evaluation value based on reference time series data 55 need only be derived, reference time series data 55 itself need not be stored in storage section 52. For example, at least one of the reference time series matrix X₂, the left singular matrix Uᵣ, and the reference characteristic matrix U₂, those being derived based on reference time series data 55, may be stored in storage section 52 in addition to or instead of reference time series data 55. In this case, control section 50 may change the above-described S130 or omit at least one of S140, S150 as required. Also in S190, control section 50 may store at least one of the reference time series matrix X₂, the left singular matrix Uᵣ, and the reference characteristic matrix U₂ in storage section 52 in addition to or instead of reference time series data 55.

In the above embodiment, control section 50 performs the anomaly determination once in one drilling operation, but the present disclosure is not limited to this. For example, in one drilling operation, control section 50 may change the period acquired as the target time-series data in S100 among the cutting periods and execute the anomaly determination process routine described above multiple times.

In the above embodiment, machine tool 10 performs the drilling process once on one object 60, but the present disclosure is not limited to this, and machine tool 10 may perform the drilling process multiple times on one object 60. In this case, the same reference time series data 55, M, N, m, and Rref may be used for multiple drilling processes. In addition, for example, appropriate reference time series data 55, M, N, m, and Rref may be used according to the processing content (for example, the depth of the hole to be formed).

In the above embodiment, the Z-axis direction is the up-down direction in FIG. 1, but the present disclosure is not limited to this. The Z-axis direction may be the axial direction of the cutting tool, in other words, the axial direction of the hole formed in object 60. For example, the Z-axis direction may be a horizontal direction such as the left-right direction.

In the above embodiment, machine tool 10 also serves as an anomaly detection device for detecting an anomaly of machine tool 10 itself, but the present disclosure is not limited to this. For example, a portion of control section 50 having a function of performing the anomaly detection process may be an anomaly detection device independent of machine tool 10. In the above embodiment, an anomaly detection device and machine tool 10 as a machine tool of the present disclosure were described, but the present disclosure is not particularly limited to this and may be in the form of an anomaly detection method or a program thereof.

The anomaly detection device, the machine tool, the anomaly detection method, and the program of the present disclosure may be configured as follows.

In the anomaly detection device of the present disclosure, the evaluation value derivation section may derive the evaluation value by using the target time series data acquired during the drilling operation that is not determined to be an anomaly by the anomaly determination section and performed within the latest predetermined number of times as the reference time series data. In this way, since the anomaly detection device derives the evaluation value when the time series data that can be regarded as relatively recent normal is used as the reference time series data, for example, even if the time series data at the time of normal drilling changes with age, it is unlikely to erroneously detect the change with age as an anomaly. Accordingly, the anomaly detection device detects an anomaly of the machine tool with higher accuracy.

In this case, the predetermined number of times may be a value 1. Accordingly, since the anomaly detection device derives the evaluation value when the time series data that can be regarded as the latest normal is used as reference time series data, it is possible to prevent erroneous detection of changes over time as an anomaly.

In the anomaly detection device of the present disclosure, the evaluation value derivation section need not use the time series data of the moving load for a predetermined period on the starting side of one drilling operation to derive the evaluation value. As a result, the number of pieces of data used to derive the evaluation value can be reduced, thus enabling reduction of the processing load of the evaluation value derivation section. In addition, even if an anomaly occurs during a predetermined period on the starting side, if the anomaly continues, the anomaly is often reflected in the evaluation value derived using the time series data of the remaining period. Therefore, even if the time series data of the moving load for the predetermined period on the starting side is not used to derive the evaluation value, the accuracy of the anomaly detection of the machine tool is unlikely to be reduced. As described above, it is possible to reduce the processing load of the evaluation value derivation section while suppressing degradation in the accuracy of the anomaly detection of the machine tool. In this case, the predetermined period may be a period including the first half of one drilling operation.

The machine tool of the present disclosure comprises:

a cutting tool configured to perform drilling,
a first driving section configured to axially rotate the cutting tool,
a second driving section configured to move the cutting tool in the Z-axis direction that is the axial direction of the cutting tool,
a time series data acquisition section for acquiring target time series data that is the time series data of a moving load in the Z-axis direction of the cutting tool during the drilling process,
an evaluation value derivation section for deriving an evaluation value indicating a degree of similarity between at least a part of the acquired target time series data and at least a part of reference time series data that is time series data of the moving load that can be regarded as normal using singular spectrum transformation, and
an anomaly determination section for determining the presence or absence of an anomaly of the machine tool based on the derived evaluation value.

Since the machine tool includes a time series data acquisition section, an evaluation value derivation section, and an anomaly determination section similar to those of the anomaly detection device described above, an effect similar to the anomaly detection device described above, for example, the effect of accurately detecting an anomaly of the machine tool can be obtained. In addition, the machine tool itself can detect the anomaly.

The anomaly detection method of the present disclosure is an anomaly detection method of a machine tool,

the machine tool comprising:
a cutting tool configured to perform drilling,
a first driving section configured to axially rotate the cutting tool, and
a second driving section configured to move the cutting tool in the Z-axis direction that is the axial direction of the cutting tool; and
the anomaly detection method comprising:
a time series data acquisition step of acquiring target time series data that is the time series data of a moving load in the Z-axis direction of the cutting tool during the drilling process,
an evaluation value derivation step of deriving an evaluation value indicating a degree of similarity between at least a part of the acquired target time series data and at least a part of reference time series data that is time series data of the moving load that can be regarded as normal using singular spectrum transformation, and
an anomaly determination step of determining the presence or absence of an anomaly of the machine tool based on the derived evaluation value.

In this anomaly detection method, an anomaly of the machine tool can be accurately detected in the same manner as the anomaly detection device described above. In this anomaly detection method, various modes of the anomaly detection device described above may be employed, or steps for achieving each function of the anomaly detection device described above may be added.

The program of the present disclosure causes one or more computers to execute the anomaly detection method described above. The program may be recorded on a computer-readable recording medium (e.g., a hard disk, ROM, an FD, a CD, a DVD, or the like), or may be distributed from one computer to another computer via a transmission medium (a communication network such as the internet or a LAN), or may be transmitted and received in any other form. When the program is executed by one computer or each step is shared and executed by multiple computers, each step of the anomaly detection method described above is executed so that the same operation and effect as those of the anomaly detection method are obtained.

### INDUSTRIAL APPLICABILITY

The present disclosure can be used in the manufacturing industry of machine tools for drilling objects as well as in various industries for performing drilling using machine tools.

### REFERENCE SIGNS LIST

10 Machine tool, 11 Base, 20 Head, 21 Head body, 22 Lifting/lowering plate, 24 Q-axis motor, 26 Drill, 30 Head moving mechanism, 32 Ball screw, 34 Z-axis motor, 36 Guide member, 40 Current sensor, 42 Z-axis position sensor, 44 Light emitting section, 50 Control section, 52 Storage section, 55 Reference time series data, 60 Object

1. An anomaly detection device of a machine tool,
the machine tool comprising:
a cutting tool configured to perform drilling,
a first driving section configured to axially rotate the cutting tool, and
a second driving section configured to move the cutting tool in the Z-axis direction that is the axial direction of the cutting tool; and
the anomaly detection device comprising:
a time series data acquisition section for acquiring target time series data that is the time series data of a moving load in the Z-axis direction of the cutting tool during the drilling process,
an evaluation value derivation section for deriving an evaluation value indicating a degree of similarity between at least a part of the acquired target time series data and at least a part of reference time series data that is time series data of the moving load that can be regarded as normal using singular spectrum transformation, and
an anomaly determination section for determining the presence or absence of an anomaly of the machine tool based on the derived evaluation value.

2. The anomaly detection device of claim 1, wherein the evaluation value derivation section derives the evaluation value by using the target time series data acquired at the time of the drilling operation, which is not determined to be an anomaly by the anomaly determination section and performed within the latest predetermined number of times, as the reference time series data.

3. The anomaly detection device of claim 2, wherein the predetermined number of times is 1.

4. The anomaly detection device of claim 1, wherein the evaluation value derivation section does not use time series data of the moving load for a predetermined period on the starting side of one drilling operation to derive the evaluation value.

5. A machine tool, comprising:
a cutting tool configured to perform drilling,
a first driving section configured to axially rotate the cutting tool,
a second driving section configured to move the cutting tool in the Z-axis direction that is the axial direction of the cutting tool,
a time series data acquisition section for acquiring target time series data that is the time series data of a moving load in the Z-axis direction of the cutting tool during the drilling process,
an evaluation value derivation section for deriving an evaluation value indicating a degree of similarity between at least a part of the acquired target time series data and at least a part of reference time series data that is time series data of the moving load that can be regarded as normal using singular spectrum transformation, and
an anomaly determination section for determining the presence or absence of an anomaly of the machine tool based on the derived evaluation value.

6. An anomaly detection method of a machine tool,
the machine tool comprising:
a cutting tool configured to perform drilling,
a first driving section configured to axially rotate the cutting tool, and
a second driving section configured to move the cutting tool in the Z-axis direction that is the axial direction of the cutting tool; and
the anomaly detection method comprising:
a time series data acquisition step of acquiring target time series data that is the time series data of a moving load in the Z-axis direction of the cutting tool during the drilling process,
an evaluation value derivation step of deriving an evaluation value indicating a degree of similarity between at least a part of the acquired target time series data and at least a part of reference time series data that is time series data of the moving load that can be regarded as normal using singular spectrum transformation, and
an anomaly determination step of determining the presence or absence of an anomaly of the machine tool based on the derived evaluation value.

7. A program for causing one or more computers to execute the anomaly detection method of claim 6.
